(19) United States
(12) Patent Application Publication
(10) Pub. No.: US 2003/0131338 A1
(43) Pub. Date: Jul. 10, 2003

(54) Resource modelling

(76) Inventor: Nektarios Georgalas, Ipswich (GB)

Correspondence Address: Nixon & Vanderhye, 8th Floor, 1100 North Glebe Road, Arlington, VA, 22201-4714, US

(21) Appl. No.: 10/221,216

(22) PCT Filed: Mar. 23, 2001
(86) PCT No.: PCT/GB01/01282

(30) Foreign Application Priority Data
Mar. 31, 2000 (EP) 00302735.6

(51) Int. Cl. G06F 9/44

(52) U.S. Cl. 717/104

(57) ABSTRACT

The present application relates to both a method of and apparatus for resource modelling and has particular application to the transformation of resource representations and thereby to the integration of heterogenous resources. In contemporary business environments, different problems and a variety of diverse requirements compel designers to adopt numerous modelling methodologies that use semantics customised to suit ad-hoc needs. This fact hinders the unanimous acceptance of one modelling paradigm and lays the ground for the adoption of customised versions of some. A particularly rich method of representing a resource is provided by the present invention, the resource having a plurality of states and associated behaviour defining transition between respective states; said method comprising representing the resource with a chosen combination of semantic elements, wherein the permissible set of semantic elements from which to choose comprises: a state class representing an element of state; a behaviour class representing an element of behaviour; a collection class representing an aggregation of one or more classes; a relationship class representing an association between two or more classes; and a constraint representing a logical expression associated with one or more classes.

The present application relates to both a method of and apparatus for resource modelling and has particular application to the transformation of resource representations and thereby to the integration of heterogenous resources.

In contemporary business environments, different problems and a variety of diverse requirements compel designers to adopt numerous modelling methodologies that use semantics customised to suit ad-hoc needs. This fact hinders the unanimous acceptance of one modelling paradigm and lays the ground for the adoption of customised versions of some.

Adequate and precise modelling is, however, key for the successful development of information systems. It is common practice, at present, to model information and system behaviour using Object-Orientated (OO) languages such as the Unified Modelling Language (UML) standard (See, for example, “UML Resource Centre, Unified Modelling Language, Standard Software Notation”, Rational Software Corporation website). It is also evident that designers pick and choose parts of languages to produce a customised modelling paradigm that suits their current requirements best. Such paradigms however constitute an amalgamation of semantic constructs and notations. Hence, although a standard, such as UML, generalises concepts and semantic constructs encountered in different paradigms in order to establish a broadly accepted modelling approach, practice works conversely, that is designers specialise and adopt extensions to the standard in order to achieve their ad hoc objectives (See, for example, “Extended Specification of Composite Objects in UML”, Vauttier et al, Journal of Object Oriented Programming, May 1999).

There are a number of important criteria by which a given model can be judged in terms of its suitability for representing a common data model, in which a variety of other more particular schemata can be expressed.

The expressiveness of a given model describes its ability to represent information modelled in diverse paradigms. In a multi-database environment, for example, a common data model must have at least sufficient expressive capability to be able to represent the expressiveness of the differing data models of the various databases.

The completeness of a given model must be such that when considering a schema transformation, the global schema must include all the features of the component logical schemata (such as constraints, concepts and structure). The completeness of the model must provide for reversibility such that a reverse schema transformation can be carried out.

Ideally, a common data model will have sufficient semantic flexibility to be able to accommodate the treatment of future schemata in terms of its transformative capabilities. This will clearly depend on its expressive richness.

Furthermore, the use of an object-oriented approach is now a widely accepted one. Object orientation both provides a pragmatic picture of the so-called Universe of Discourse and allows for ease of transformation into system implementation. Consequently, a schema expressed in an object oriented modelling language is likely to be more comprehensible and easier to implement.

Models such as the Object Data Management Group (ODMG) model have been considered in terms of the above. See, for example, “Evaluating the ODMG Object Model for Usage in a Multidatabase Environment”, Mark Roantree, Dublin City University Working Paper CA2597, 1997. The Universal Modelling Language (UML) and Object Role Modelling (ORM) approaches (See, for example, “UML data models from an ORM perspective: part one”, Halpin, Journal of Conceptual Modelling, Vol 1, Issue 1, April 1998) and the Entity-Relationship approach (See, for example, “An Argument for the Use of ER Modelling”, Becker, Journal of Conceptual Modelling, August 1999) have also been considered. A general consideration of Metamodelling is provided in “Metamodelling in EIA/CDIF-Metametamodel and Metamodels”, Flatscher, Information Modelling in the Next Millenium, Idea Group Publishing, 2000.

Each of these models has however lacked generality in terms of the properties discussed above. In particular, object-oriented approaches have tended to lack flexibility due to the specificity of their semantics, as noted above.

According to one aspect of the present invention there is provided a method of representing a resource, the resource having a plurality of states and associated behaviour defining transition between respective states; said method comprising representing the resource with a chosen combination of semantic elements, wherein the permissible set of semantic elements from which to choose comprises: a state class representing an element of state; a behaviour class representing an element of behaviour; a collection class representing an aggregation of one or more classes; a relationship class representing an association between two or more classes; and a constraint representing a logical expression associated with one or more classes.

Advantageously, in this way, a resource representation is provided which possesses a particularly rich expressive capability.

In particular, denoting this resource representation, MOP:

classification. Everything in MOP is modelled as a class. MOP classes can instantiate other MOP classes, hence schemata can be organised at different levels according to their abstraction.

unified representation of object state and behaviour. Both are uniformly treated since MOP has class as its basic representation mechanism. This is a unique feature, which contrasts with traditional OO approaches. There, object state and behaviour are described as part of a class.

aggregation. MOP provides an explicit mechanism to define complex aggregated objects.

minimum set of representation mechanisms. MOP supports a small number of mechanisms capable of representing very complex concepts. Hence, simplicity does not compromise modelling flexibility.

According to a second aspect of the present invention there is provided a method of transformation of resource representations, a resource having a plurality of states and associated behaviour defining transition between respective states; the method comprising: receiving a first representation of the resource; transforming said first representation of the resource into a second representation of the resource, the second representation of the resource comprising a chosen combination of semantic elements, wherein the permissible set of semantic elements from which to choose comprises: a state class representing an element of state; a behaviour class representing an element of behaviour; a collection class representing an aggregation of one or more classes; a relationship class representing an association between two or more classes; and a constraint representing a logical expression associated with one or more classes.

The richness of expressive capability provides particular advantage in terms of the generality with which other resource models, through transformation, may be represented in terms of the resource representation according to the invention.

According to a third aspect of the present invention there is provided A method of integration of heterogenous resources, a plurality of resources each having a plurality of states and associated behaviour defining transition between respective states and each respective resource being associated with a resource representation; the method comprising: receiving each respective resource representation; and transforming each respective resource representation into a common resource representation, the common resource representation comprising a chosen combination of semantic elements, wherein the permissible set of semantic elements from which to choose comprises: a state class representing an element of state; a behaviour class representing an element of behaviour; a collection class representing an aggregation of one or more classes; a relationship class representing an association between two or more classes; and a constraint representing a logical expression associated with one or more classes.

The generality with which other resource models, through transformation, may be represented in terms of the resource representation according to the invention provides particular advantage in tackling the problem of integration of heterogenous resources. In this way, a variety of heterogenous resource representations can all be transformed in the resource representation according to the invention, providing an apparently integrated commonly represented resource.

Commensurate apparatus is also provided.

A number of embodiments of aspects of the invention will now be described with reference to the accompanying drawings, in which:

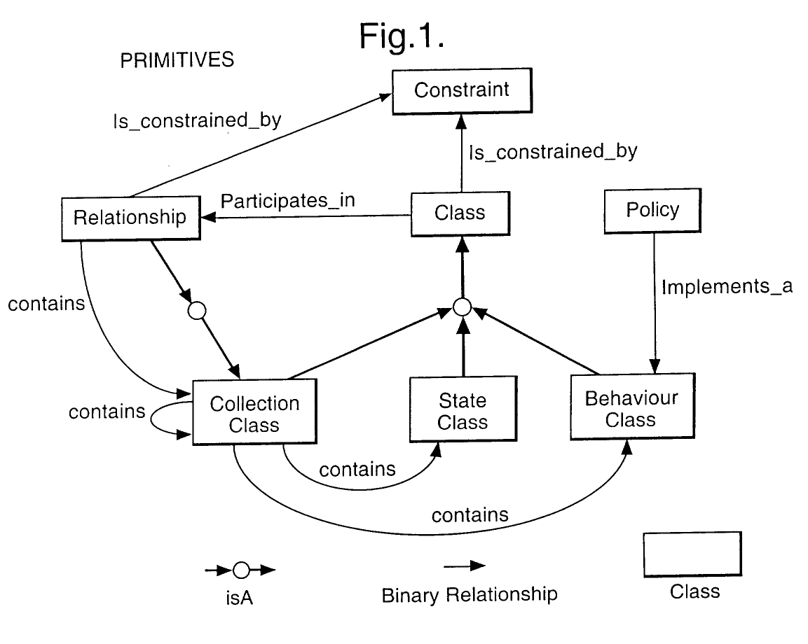

FIG. 1 represents an illustration of the semantic structure of the Object Primitives information model;

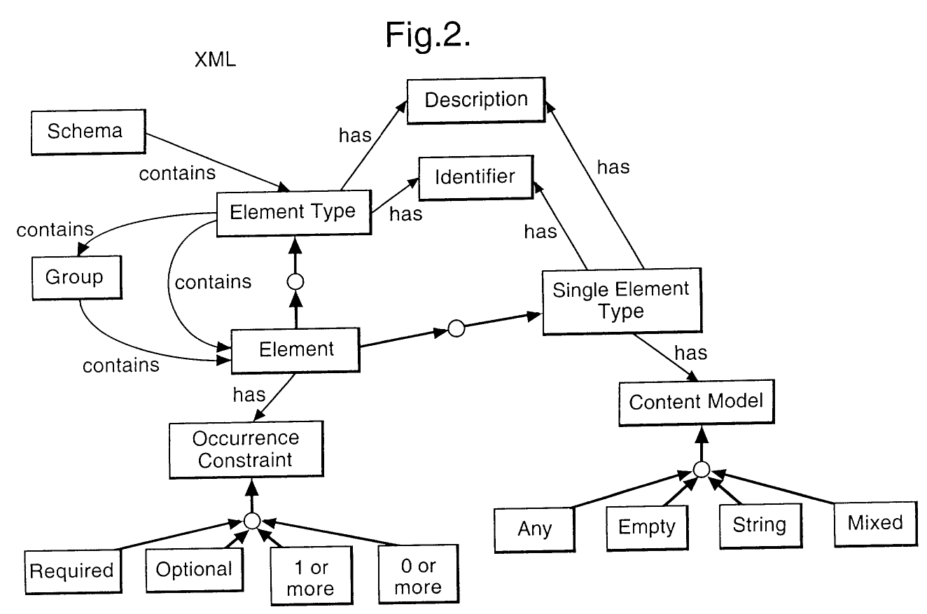

FIG. 2 represents an illustration of the semantic structure of the extensible Markup Language (XML) information model;

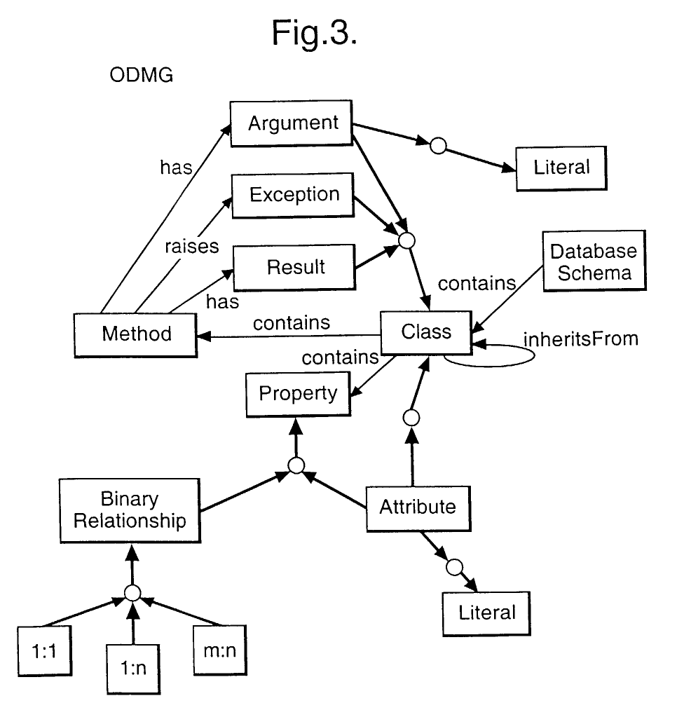

FIG. 3 represents an illustration of the semantic structure of the Object Data Management Group (ODMG) information model;

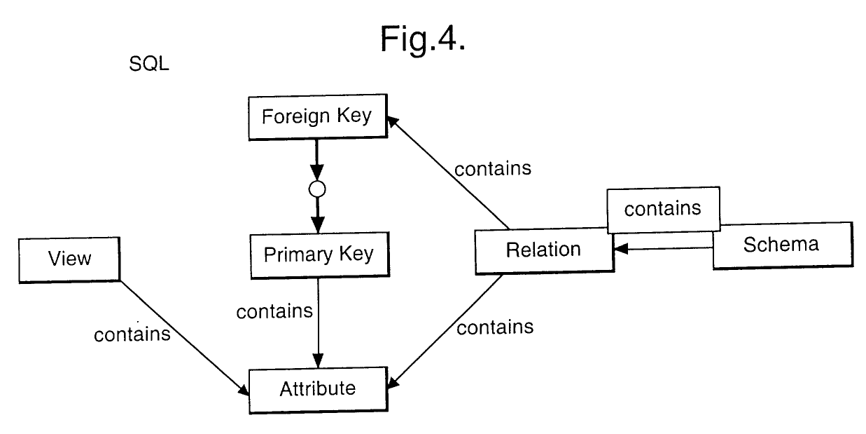

FIG. 4 represents an illustration of the semantic structure of the Relational Data Model;

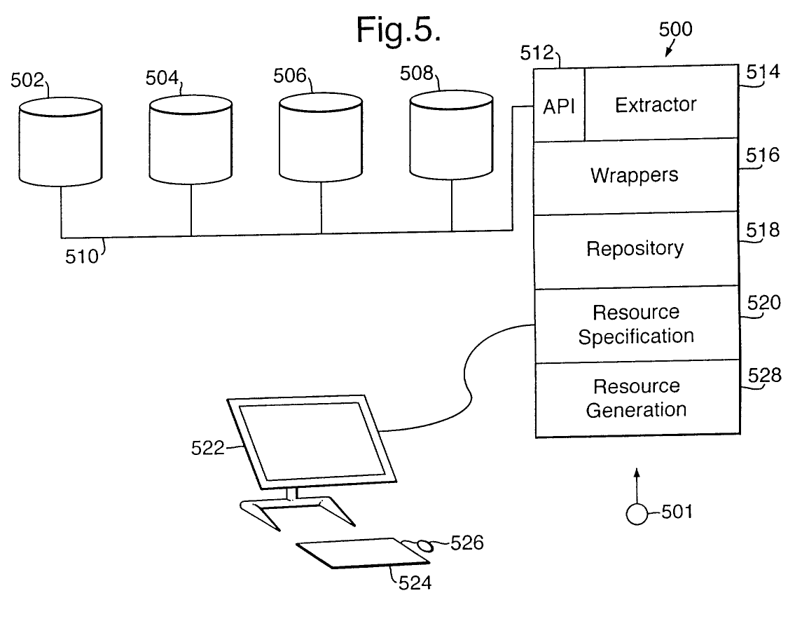

FIG. 5 represents a resource integrating architecture suitable for use with an aspect of the present invention;

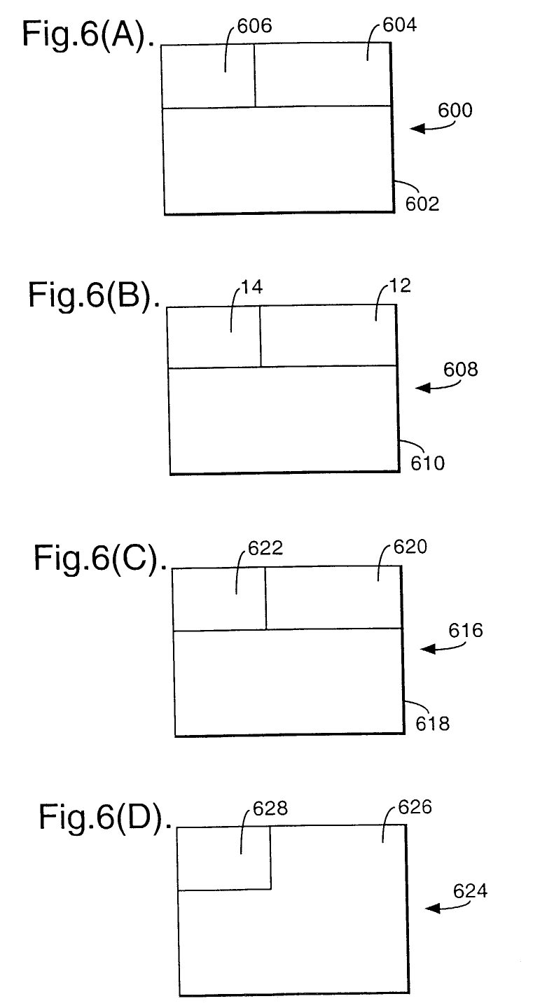

FIG. 6 represents schematic illustrations of four resource sources; and

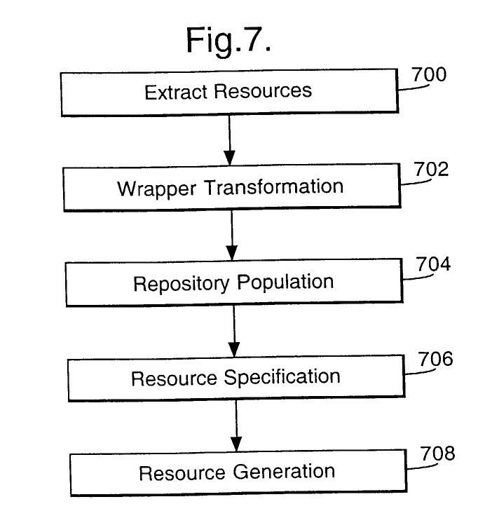

FIG. 7 represents a flowchart of a one example of a resource integration process suitable for use with an aspect of the present invention.

A first section will now discuss the so called Model of Object Primitives. A second section will then discuss three examples of representation of resources in the Model of Object Primitives (XML, ODMG and relational models). A third section will illustrate one example of an application of the Model of Object Primitives to the problem of integration of heterogenous resources.

Introduction to Model of Object Primitives

A schematic illustration of the semantics of the Model of Object Primitives is illustrated in FIG. 1.

Object-orientated methods attempt to analyse and model entities relevant to a problem domain as objects of a specific class type. An object has state, which can change in the course of time, and presents certain behaviour. State is reflected in the values of the object attributes and behaviour is determined by the methods the object implements. Additionally, a class is perceived to be the abstraction that describes state and behaviour characteristics for objects of the same type. In other words, a class acts as a template that packages together data variables and methods. Hence inevitably, state and behaviour become concepts that tightly associate their identity with the objects of a certain class.

Objects are analysed in their founding constituents, data and methods i.e. state and behaviour. In MOP, these primitive atoms are each modelled as a separate class. MOPClass is the premium semantics mechanism of MOP. Object primitives are modelled as State Classes and Behaviour Classes (a Behaviour Class will alternatively be referred to as method), which are special forms of MOPClass. A State Class models the state/data variables encountered in objects and a Behaviour Class models object methods. Another form of MOPClass is Collection Class. This packages together other MOPClasses, e.g. State, Behaviour or even Collection Classes, to construct more complex structures. This point is where MOP meets the classic 00 paradigms, since a designer can use Collections to assemble the appropriate data variables and methods and build a construct similar to a class with the traditional sense i.e. a Java or UML class. Relationship is another MOP semantics that indicates an association between two MOPClasses. MOP supports Constraints, which specify certain limitations a designer wants to apply on MOPClasses. For instance, ownership relationships, isA relationships—inheritance—, weak entities can be modelled as plain relationships or classes augmented with a constraint appropriately defined to capture the restrictive properties for each case. Finally, Policies are used as the means to specify behaviour in MOP. They are associated with Behaviour Classes and are intended to describe the way the latter deliver their services.

In the following sections the basic semantics of MOP are examined, namely, MOPClass, State Class, Behaviour Class, Collection Class, Relationship, Constraint and Policy.

MOPClass

A MOPClass is the cornerstone of the MOP semantics. It is never used directly when building a schema in MOP. It constitutes instead the root construct that is extended in order to implement each one of the primary MOP classes described below—state, behaviour, collection, relationship. Hence, it accumulates the features that are commonly encountered among them. Everything in MOP is modelled as a class that is generally of type state, behaviour, collection or relationship. Since the latter types inherit from the root, any class can be considered as an instance of MOPClass. An instance of MOPClass is characterised by the structure <id, name, description, MOPClass[ ] type>. id is a not nullable and unique integer that distinctively identifies different classes. The name attribute indicates the name of the class. More than one name can be given at definition of a class serving as alternative aliases. Description is a free-text description of what the class represents. This is an optional attribute hence it may be omitted. The type feature specifies the classes that the current one instantiates. The primitives model supports classification, that is a MOPClass can instantiate other, more abstract classes. These abstract classes reside at levels of abstraction higher than their instances. Additionally, MOP supports multiple instantiation i.e. a class can be instance of more than one abstract class; hence, a MOPClass can have more than one types. This is the reason for representing the type feature as an array.

Classification is a property encountered in several semantic models, such as the TELOS knowledge representation language (See, for example, “Telos: Representing Knowledge about Information Systems”, Mylopoulos et al, ACM Transactions on Information Systems, Vol 8, No 4, October 1990). It introduces the principle of meta-modelling where someone can build “models that describe models” (See, for example, “Metamodelling in EIA/CDIF—Meta-metamodel and Metamodels”, Flatscher, Information Modelling in the New Millenium, Idea Group Publishing 2000). More specifically, classification makes classes be considered as instances of other classes. This feature manifests in MOP through the typing mechanism, which considers that each MOPClass has a type, i.e. it is an instance of other, more abstract classes. This arrangement organises MOPClasses in conceptual/abstract planes, which construct a bottom-up hierarchy. A similarly layered architecture is adopted by the EIF/CDIF standard (See, for example, Flatscher above), which is, however, restrained to only four levels. Classification in MOP is unlimited therefore the number of abstraction layers is also unlimited. The lowest layer M0 is occupied by MOPClasses that can not be further instantiated because they represent concrete values such as integers and Strings (The layer names M0, M1, M2 are chosen to be compatible with the names adopted by the EIF/CDIF standard). Levels M1, M2 and above host instantiable MOPClasses. In order to show that a MOPClass A instantiates a MOPClass B we may use the keyword instanceOf and write A instanceOf B.

Generally, a MOPClass is modelled with one exclusive type of primitive, for instance, State Class or Collection Class. However, a MOPClass might happen to have some instances represented as State Classes and others as Collections. Such case is encountered in Table 2 below which describes the mappings of ODMG semantics unto MOP. In there it is shown that an Attribute can be represented in MOP as a State Class or a Collection. To avoid modelling inconsistencies, it is necessary that the concept Attribute is captured in a way that facilitates its instantiation by State Classes and Collections. This is generally achieved by defining the concept as a MOPClass and declaring in its type feature the primitive types expected to encounter among the concept instances. In the particular example, the Attribute should be defined as MOPClass and the type feature should be set to StateClass and CollectionClass, as shown below.

MOPClass ODMGAttribute {

type: StateClass, CollectionClass

}

State Class

A State Class inherits all features of the root MOPClass and it is modelled with an almost similar structure <id, name, description, type, contentType>. The only additional property observed is contentType. This is introduced for usage merely by Ml State Classes. It indicates the type that the M0 instances of a M1 State Class should have. Consequently, the contentType feature can be regarded equivalent to applying a constraint that forces all instances of the current State Class to be simultaneously instances of the contentType-specified MOPClass. However, generally and in the interest of simplicity, it is preferable to use the contentType feature, which implies a constraint, rather than explicitly applying the constraint per se.

An example is shown below, where Name is defined in two equivalent ways: as a State Class with contentType String and as a State Class with a constraint that forces all its instances to be of type String. Both declarations would dictate that State Class Aris, should be a String. Alternatively, this can be achieved if Name does not include the contentType feature and Aris sets its type to Name and String. But, in general, the process of constructing a schema that models a problem domain—this would reside on M1—comes first to the population of the schema with real world entities—these would reside on M0. Hence, for completeness, each M1 class of the schema should include all properties that their M0 instances are expected to satisfy. In the same way, the introduction of contentType in the definition of M1 State Classes aims at specifying in advance the additional type of their M0 instances.

| | | |
|---|---|---|
| StateClass Name { | StateClass Name{ | StateClass Name { |
| type: | type: ODMGAttribute | type: ODMGAttribute |
| ODMGAttribute | | |
| contentType: | constrainedBy: ∀ i | } |
| String | | |
| } | instanceOf this, i | StateClass Aris { |
| StateClass Aris { | instanceOf String | type: Name, String |
| type: Name | } | } |
| } | | |

The contentType feature should refer to types that are either State Classes or Collections of State Classes.

MOP is a purely class-based model. Therefore, it does not support any atomic data types (else known as literals) such as int, short, char etc, which are typically used in data definition languages. Instead, these literals are wrapped up in MOPClasses in order for these to become the built-in types of MOP and for MOP to persist its class-based profile. The idea of wrapping literals into classes is also encountered in Java. MOP supports a default set of built-in types that includes Character, String, Integer, Long, Float, Double, Boolean. These types are considered to be State Classes and resemble the set of Java classes that wrap up Java literals. This is because MOP is implemented on Java. The set of MOP built-in types should be enriched if requirements so dictate. For example, this ought to happen when integrating a new model that supports literals not included in or not bound to the MOP literals of the built-in set. These literals should be wrapped up as MOPClasses and comprise part of the built-in MOP types.

Behaviour Class

A behaviour class is a primitive MOPClass that is modelled as a structure of the form <id, name, description, type, MOPClass[ ] argumentTypes, MOPClass[ ] argumentValues, MOPClass resultType, MOPClass[ ] resultValues>. The first features are inherited from the root MOPClass. ArgumentTypes is an array that registers the MOPClasses representing types of input permitted for use by the class. ArgumentValues is an array with MOPClasses that are the input values for the Behaviour Class. These values should comply with the respective types stated in argumentTypes, that is each argumentValue should be an instance of an argumentType. ReturnType designates the MOPClass that represents the type of output of the Behaviour Class. Finally, resultValues is an array of values—MOPClasses—that are of type resultType and are potential outputs of the class.

ResultValues exists only if the Behaviour Class belongs to the predetermined results Behaviour Class category. This category includes Behaviour Classes that return results from a specified and finite set of discrete values a priori determined. For instance, in this category fall methods with resultType Boolean, since their resultValues is [True, False]. In contrast with this, there exists the no predetermined results Behaviour Class category where outcomes of the performed behaviour are not a priori known. This holds mainly because the values that such methods return depend on results reached at runtime. Consequently, the resultValues feature of Behaviour Classes belonging in the latter category is null.

An example is presented next that demonstrates the way a MOP Behaviour Class is defined. The example assumes concepts of an ODMG schema mapped to MOP according to Table 2 below:

| | |
|---|---|
| StateClass name { | BehaviourClass isMale { |
| type: ODMGClass | type: ODMGMethod |
| contentType: String | argmumentTypes: name |
| } | resultType: Boolean |
| | resultValues: True, False |
| | } |

The main contribution of a Behaviour Class is that it separates the implementation and focuses on the description of method properties. This makes a Behaviour Class similar to the concept of an interface, such as a Java interface, which contains signatures of methods and omits their implementations. There is, however, a significant difference.

Basically, a MOP Behaviour Class refers directly to one behaviour atom i.e. one method. A Java interface acts as a package of behaviour that may contain more than one method description. Therefore, an interface is literally equivalent to a Collection of Behaviour Classes. This atomic treatment of behaviour in Behaviour Classes combined with the aggregating capability of Collections leverages the construction of optimal interfaces. This is because methods in MOP are recognised building blocks and can be individually referenced in order to construct a new interface. In Java or other languages there is not direct semantics support for method descriptions other than considering them as part of an interface; hence when a new interface is to be constructed it needs to be built entirely from scratch. It is to be noted however that in Java, an interface can extend another interface and hence inherit all existent method descriptions. But even then, if there were a requirement to tailor a new interface i1 with method descriptions that already exist and constitute parts of interfaces i2 i3 and i4, i1 would still include undesired methods, since it has to extend i2 i3 and i4 and hence inherit the surplus methods alongside the useful ones. The only way to avoid that is to model numerous interfaces including only one method and then let i1 extend those that refer to the methods it needs. This is exactly the approach MOP follows with the difference that methods are directly described as Behaviour Classes instead of being included in thin interfaces.

Collection Class

A Collection Class is a MOPClass intended to provide for the concept of aggregation. It can be modelled as a structure that contains other MOPClasses—state, behaviour, collection and relationship. Alternatively, one can view a collection class as an unordered set of classes and relationships that may contain a variant number of members each time a new collection is defined. A collection has the form <id, name, description, type, MOPClass[ ]>. The first features are inherited from the root MOPClass. The MOPClass[ ] array keeps a list of the MOPClasses that are members of the collection.

The keyword memberOf is used at the definition of a MOPClass when it is to be declared as a member of a collection. However, it is preferable and more comprehensible to declare within a Collection the classes it includes. This is done with the keyword members, which is used at the definition of the Collection Class. Here follows an example that presents both alternative ways of member declaration. It is assumed that the concepts belong to an ODMG schema that is mapped to MOP according to Table 2 below:

| | | |
|---|---|---|
| CollectionClass Employee{ | | CollectionClass Employee{ |
| type: XMLElementType | | members: Name |
| } | or | } |
| StateClass Name{ | | StateClass Name{ |
| type: XMLElement | | type: XMLElement |
| memberOf: Employee | | contentType: String |
| contentType: String | | } |
| } | | |

in instances of a Collection, each member may be instantiated more than once. This, in fact, shows that each member can have multiple values in one Collection instance.

There are two operators that can be used with a Collection Class. The first is CollectionClass[ ] memberOf (MOPClass) which applies to any MOPClass and retrieves an array of Collections that the MOPClass belongs to. It is common to use this operator as a keyword in clauses of the form A memberOf B to claim that A belongs to Collection B. The second operator has the reverse effect. It is MOPClass[ ] members (CollectionClass) and returns an array of MOPClasses that belong to a specific Collection.

A Collection can be defined without a name. This leverages the representation of a group of concepts when it is not necessary to explicitly reference this group by name. The definition of such Collection leaves the name feature null.

Relationship

A Relationship in MOP becomes a first class citizen since it is treated as a MOPClass. This fact contradicts the concept of a relationship, as it is perceived in ODMG.

There, “a relationship is not itself an object an does not have an object identifier. It is defined implicitly by declaration of traversal paths that enable applications to use the logical connections between the objects participating in the relationship” (See, for example, “The Object Database Standard: ODMG 2.0”, Cattel et al, Morgan Kauffman Publishers, San Francisco 1998).

A MOP Relationship is captured as a binary association that links two MOPClasses. Therefore, it is a Collection Class in the sense that it aggregates two parties in the association. A MOP Relationship is unidirectional, that is there is an originator and a destination class. The start and end of the Relationship are respectively declared in the from and to section of the Relationship definition. Alternatively, a Relationship can be defined within another class in a similar way. In this case, the hosting class is assumed to be either the originator or the destination of the association, hence the from or to section is respectively omitted from the Relationship definition. Furthermore, a Relationship should, at definition, state its type/s. This implies that Relationships instantiate other more abstract ones. That is a benefit gained from considering a Relationship to be a MOPClass, therefore classification applies to it in the same way it applies to MOPClasses.

The basic features of a MOP Relationship are exhibited in the example below. There we assume that the represented concepts are part of an ODMG schema whose semantics is modelled in MOP according to the mappings shown in Table 2.

| | | |
|---|---|---|
| CollectionClass Employee{ | | |
| type: ODMGClass | | CollectionClass Department{ |
| } | | type: ODMGClass |
| CollectionClass Department { | or | } |
| type: ODMGClass | | CollectionClass Employee{ |
| } | | type: ODMGClass |
| Relationship works for { | | Relationship works for { |
| type: ODMGRelationship from | | type: ODMGRelationship from |
| ODMGClass | | ODMGClass |
| from: Employee | | to: Department |
| to: Department | | } |
| } | | } |

There are two specific operators that apply to a MOP Relationship; MOPClass from (Relationship) that identifies the originator class of the Relationship and MOPClass to (Relationship) which returns the destination class.

The semantics of a Relationship are very generic as it can associate different types of MOPClasses. For instance, associated can be amongst them state, behaviour, collection classes and even relationships, since the latter are also MOPClasses in their own right. Additionally, a Relationship is allowed to have its own attributes. This is a feature encountered in many OO models such as the Unified Modelling Language (UML). In MOP this is achieved by aggregating the MOPClasses that represent the attributes within the collection of the Relationship. Then, the Relationship would appear to contain the attribute MOPClasses in addition to the originator and the destination class.

In models, such as the Extended-Entity-Relationship (EER) model, relationships can only be of one of three types determined by their cardinality ratios, namely, one-to-one, one-to-many and many-to-many. A MOP Relationship is different in that it stands alone as a concept. However, a more specialised type of relationship can be constructed, if necessary, by the augmentation of a MOP relationship with a special constraint. This is feasible as MOP relationships are collection classes and therefore constraints can apply on them. Specific examples are studied in the sections that follow.

Constraint

A constraint applies on MOP classes and relationships in order to enforce restrictions on their characteristics or instances. Constraints are related with their restricted parties through the keyword constrainedBy. A class or relationship can establish an association with a constraint either at the time of definition or when included as part of another construct such as a Collection. In the former case the constraint will apply always, wherever and whenever the class occurs. In the latter case, the constraint will only be enforced within the local/special boundaries of the declaration. A useful keyword when expressing a constraint is this, which identifies the class that the constraint applies on. If the constraint applies on a class that is included within another then this refers to the embedded and not the overall class. In other cases, this refers to the MOPClass wherein it is used. Examples of constraints are given in the sections below where MOP semantics are used for the representation of XML and ODMG.

Policy

Policies are traditionally used in the areas of Network Management and Distributed Systems (See, for example, “Policy Service for Distributed Systems”, Marriot, PhD thesis, Dept of Computing, Imperial College, London, June 1997). Several policy languages have been developed to address security issues (See, for example, “EPSRC Grant GR/1 96103-SecPol: Specification and Analysis of Security policy for Distributed Systems”, Sloman et al, Dept of Computing, Imperial College, London), such as access control, and network issues (See, for example, “Active IETF Working Groups: Policy Framework (Policy)—Charter” at IETF website), such as allocation of network resources and configuration of devices to meet certain QoS criteria. In general, policies have been targeted for low-level (network level) and administrative control applications. What is missing is a dimension where policies can be used to specify high-level behaviour and by this, of course, is meant object behaviour.

A Policy in MOP is tightly coupled with a Behaviour Class. While the latter is intended to specify static characteristics of behaviour, such as name of method and type of method arguments, the former aims at describing the dynamic features of behaviour i.e. the way this behaviour is performed. Practically, a Policy is the service specification for a Behaviour Class; that is, it implements the service the behaviour class is meant to deliver.

Expressing Policies is typically a very challenging issue. This is especially because of the main objective that policies are meant to address, i.e. describing object behaviour. Two ways of modelling are presented here.

First, Policies are considered to be a set of Condition-Action rules. Based on the true or false of a condition, the Policy continues either with executing a sequence of actions or with checking another condition. This representation has been applied in the first example presented below.

Second, a policy is modelled as a set of linked nodes. Each node represents some primitive behaviour i.e. a Behaviour Class. A node has as many outputs as values appear in the resultValues feature of the respective Behaviour Class. The Policy executes one node and then follows onto the next, according to the result. This is a more generic representation than the first and has been applied in the second example presented below.

The convenience of both representations is that they can be visually modelled as graphs. This grants great flexibility in managing Policies and provides grounds for the implementation of user-friendly Policy management tools. The policy representation may be extended further such that it captures events. State Transition Diagrams and events are broadly accepted in OO design paradigms, such as UML, as the means to model object behaviour. Incorporation of events will also provide a strong modelling element to capturing interaction between behaviour components, which is often a common and rather complex situation. This basically refers to a case where some behaviour b1 starts, then stalls, waits for behaviour b2 to perform and then continues again in a direction that is dependent on b2's results; events can work out the communication string between b1 and b2. Some relevant work is presented in, for example, “A Policy Description Language”, Lobo et al, Proceedings of AAAI99 Conference, Orlando, Fla., July 1999, where an event-based Policy description language is proposed.

A Behaviour Class becomes related to a MOP Policy with the keyword implementedBy. A policy can be related to—implement—more than one Behaviour Class and, conversely, a Behaviour Class can be related to—be implemented by—many policies. This corresponds to a Java feature where classes can implement more than one interface and interfaces can be implemented by more than one class.

Policies do not get instantiated; only Behaviour Classes do. This is so because the role of a Behaviour Class is to represent a piece of behaviour as a concrete entity. Therefore, it is sensible that only them are instantiable. On the other hand, Policies simply describe a service specification, which should be delivered by the associated method. A Policy is not a MOPClass and as such it cannot have instances.

Information Model Representation Case Studies

In this section the generality and flexibility of MOP is studied in representing different data-models, XML and OO in particular. It is intended to demonstrate that MOP can be placed at the last abstraction layer of the above mentioned model—M4—i.e., above the layer of data-model descriptions, and hence provide the leverage for the generic representation of a variety of information models with data and behaviour characteristics.

XML in Object Primitives

XML is illustrated in FIG. 2 as a meta-model of the basic semantics it uses.

The construction of this meta-model is based on the specification of XML given in “XML Data”, World Wide Web Consortium (W3C) website, January 1998. The structure of the information contained in a XML document is declared by a schema. The schema includes several sorts of element types. Single or atomic element types carry an identifier and optionally a description. However, more complex element types may exist that consist of properties/elements. These types will be referred to as composite element types. Elements are also defined as element types that in turn can be either single or composite. Each element within an element type specifies whether it is optional or required and if it occurs in the type 0,1, or many times. The structure of an element type is called content model. Specifically for single element types the content model determines whether the element type is Empty, a String, a mixture of characters and content of declared element types or a mixture of contents from any element type contained in the schema but no free characters. A group indicates a set or sequence of elements within a composite element type and it is treated similarly to an element. Element types can be organised into class hierarchies with subtypes and supertypes where an instance of the subtype is also an instance of the supertype. When the supertype is declared as genus of the subtype, then the latter additionally inherits the supertype's elements.

TABLE 1
XML to MOP mappings

| XML semantics | MOP representation |
|---|---|
| Schema Element Type | Collection Class |
| Single Element Type | State Class |
| Identifier | Name |
| Description | Description |
| Content (Empty, Any, String, | ContentType |
| Mixed) | |
| Composite Element Type: | Collection Class |
| Single Element Type + (Required, | State Class + |
| | occurrenceConstraint |
| Optional, OneOrMore, | |
| ZeroOrMore) | |
| Composite Element Type + | Collection Class (of Composite |
| (Required, Optional, OneOrMore, | Element Type template) + |
| ZeroOrMore) | occurrenceConstraint |
| Group | Collection Class with no name |
| Supertype | Relationship + subsetConstraint |
| Genus | Relationship + subsetConstraint + |
| | inheritanceConstraint |

Table 1 illustrates the mapping of XML semantics on MOP. More analytically, the table shows that:

a schema in XML maps to a Collection Class.
CollectionClass XMLSchema {

members: XMLElementType

}
This is because a schema contains element types in the
same sense a Collection
Class includes MOPClasses.
an element type is modelled as State Class if it is single
and as Collection Class if it is
composite.
MOPClass XMLElementType{

type: CollectionClass, StateClass

}

An element type's identifier and description correspond to MOPClass name and description. For a single element type the content model corresponds to the contentType feature of the State Class. The string content model is equivalent to declaring a String contentType. Any is equivalent to a contentType that declares a Collection of State Classes. The Collection is constrained to contain State Classes of type XMLElementType that belong to the same XMLSchema as the single Element Type. A mixed content model similarly indicates a contentType of Collection Class. The Collection contains String or State Classes of type XMLElementType.

For composite element types the respective MOP Collection contains State Classes which represent single element type elements or other Collections which model composite element type elements. In analogy to the required occurrence value, a MOP constraint is applied on the respective Collection member that forces it to be not nullable for all instances of the Collection. Without this constraint, members can be null in some cases and this corresponds to the optional occurrence value. OneOrMore and ZeroOrMore values are covered by the property of the Collection members to acquire multiple values within a Collection instance.

a group is modelled as a Collection Class without a name.

subset relationships and inheritance, declared respectively by the superType and genus XML attributes, are modelled as MOP Relationships augemented with Subset and Inheritance constraints. The former ensures that instances of an MOPClass of type XMLElementType, which is the start for a Relationship of type SubsetOf, should be instances of the MOPClass, which ends the Relationship. The latter forces members of a MOPClass, which is of type XMLElementType and ends a Relationship of type InheritsOf, to be members of the MOPClass that starts this Relationship.

| | |
|---|---|
| Relationship SubsetOf{ | Relationship InheritsFrom{ |
| from: XMLElementType | from: XMLElementType |
| to: XMLElementType | to: XMLElementType |
| constrainedBy: Subset | constrainedBy: Subset, Inheritance |
| } | } |

Constraint Subset: (∀i instanceOf this, k instanceOf from(i) [symbol] k
instanceOf to(i) )
Constraint Inheritance: (∀i instanceOf this, m memberOf to(i) [symbol] m
memberOf
from(i) )

A full example of an XML schema represented in MOP is given below.

| | |
|---|---|
| XML | MOP |
| <s:schema id = ‘ExampleSchema’> | CollectionClass ExampleSchema { |
| <elementType id = “Name”> | Type: XMLSchema |
| <description> The name of some | Members: Name, Person, Author, |
| person </description> | Title, Preface, Introduction, Book, |
| <string/> | Price, ThingsRecentlyBought, |
| </elementType> | BooksRecentlyBought |
| | } |
| <elementType id = “Person”> | StateClass Name { |
| <any/> | Type: XMLElementType |
| </elementType> | contentType: String |
| | } |
| <elementType id = “Author”> | StateClass Person { |
| <mixed> <element type = “Name”> | type: XMLElementType |
| </mixed> | contentType: CollectionClass |
| </elementType> | constrainedBy Any |
| | } |
| <elementType id = “Title”> | StateClass Author { |
| <string/> | type: XMLElementType |
| </elementType> | contentType: |
| | CollectionClass { |
| <elementType id = “Introduction”> | members: String, Name |
| <string/> | } |
| </elementType> | } |
| | StateClass Title{ |
| <elementType id = “Preface”> | type: XMLElementType |
| <string/> | contentType: String |
| </elementType> | } |
| | StateClass Introduction{ |
| <elementType id = “Book”> | type: XMLElementType |
| <element type = “#Title” occurs = | contentType: String |
| ”REQUIRED”/> | } |
| <element type = “#Author” occurs = | StateClass Preface{ |
| “ONEORMORE”/> | type: XMLElementType |
| <group occurs = “REQUIRED”> | contentType: String |
| <element type = “#Preface”/> | } |
| <element type = “#Introduction”/> | CollectionClass Book { |
| </group> | type: XMLElementType |
| </elementType> | members: Title constrainedBy |
| | Required, Author, |
| <elementType id = “Price”> | CollectionClass { |
| <string/> | members: Preface, Introduction |
| </elementType> | } constrainedBy Required |
| | } |
| <elementType | StateClass Price { |
| id = “ThingsRecentlyBought”> | type: XMLElementType |
| <element type = “#Price”/> | contentType: String |
| </elementType> | } |
| | CollectionClass ThingsRecentlyBought{ |
| <elementType | type: XMLElementType |
| id = “BooksRecentlyBought”> | members: Price |
| <genus type = “#Book”> | } |
| <superType | CollectionClass BooksRecentlyBought{ |
| type = “#ThingsRecentlyBought”/> | type: XMLElementType |
| <element type = “#Price”/> | members: Price |
| </elementType> | Relationship inheritsBook { |
| </s:schema> | type: InheritsFrom |
| | to: Book |
| | } |
| | Relationship subsetsThings { |
| | type: SubsetOf |
| | to: ThingsRecentlyBought |
| | } |
| | } |

Constraint Any: (∀i instanceOf this, m memberOf i [symbol] m memberOf ExampleSchema)
Constraint Required: (∀i instanceOf this, [symbol] (i = null) )

ODMG in Object Primitives

ODMG is illustrated in FIG. 3 as a meta-model of its basic semantics.

The construction of the meta-model is based on the ODMG specification presented in “The Object Database Standard: ODMG 2.0”, Cattel et al, Morgan Kauffman Publishers, San Francisco 1998. The ODMG semantics are similar to any 00 language and therefore no further detailed description is provided.

TABLE 2
ODMG to MOP mappings

| ODMG semantics | MOP representation |
|---|---|
| Database Schema | Collection Class |
| Class | Collection Class |
| Attribute | State or Collection Class |
| Relationship | Relationship |
| Method | Behaviour class + Policy |
| Attribute | State or Collection Class |
| Relationship (1:1, 1:n, m:n) | Relationship + cardinalityConstraint |
| Method | Behaviour Class |
| Inheritance | Relationship + InheritanceConstraint |

Table 2 presents the mappings between ODMG and MOP. More analytically:

| a database schema is modelled as a Collection Class. | | |
|---|---|---|
| CollectionClass ODMGSchema{ | | |
| members: ODMGClass | | |
| } | | |
| Every instance of ODMGSchema should include MOPClasses that represent ODMG | | |
| classes of a database schema. | | |
| a class in ODMG contains attributes, relationships and methods hence it is modelled | | |
| as a Collection Class. | | |
| CollectionClass ODMGClass { | | |
| members: ODMGAttribute, ODMGMethod, ODMGRelationship | | |
| } | | |
| an attribute can have as type either a literal, such as string or float, or another class | | |
| of the same schema. In the former case it is modelled as State Class and in the latter | | |
| as a Collection. | | |
| MOPClass ODMGAttribute{ | | |
| type: CollectionClass, StateClass | | |
| } | | |
| [ODMG 1998] presents the ODMG- Java binding and it shows how ODMG literals | | |
| map to Java classes that wrap up the Java literals. This mapping similarly applies on | | |
| ODMG and MOP literals, since the set of MOP built-in types resembles the set of Java | | |
| wrapped literals, as mentioned in Section ... | | |
| StateClass ODMGLiteral{ | | |
| type: String, Character, Integer, Long, Float, Double, Boolean | | |
| } | | |
| a method is represented as a Behaviour Class. The types of its arguments and results | | |
| are ODMGClass or ODMGLiteral. A method in ODMG raises an exception when an | | |
| error occurs. An exception is modelled as a Behaviour Class, which is related to | | |
| ODMGMethod with the ODMGRaises Relationship. | | |
| BehaviourClass ODMGMethod { | | BehaviourClass ODMGException{ } |
| argumentTypes: | ODMGClass, | Relationship ODMGRaises { |
| ODMGLiteral | | from: ODMGMethod |
| returnType: | ODMGClass, | to: ODMGException |
| ODMGLiteral | | } |
| } | | |

| a relationship is directly mapped to a MOP Relationship. An arising issue is that a | | |
|---|---|---|
| MOP Relationship is uni-directional whereas a ODMG relationship is bi-directional. It is | | |
| at the designer's disposition to choose one of the two ODMGClass instances involved | | |
| as the originator for the MOP Relationship. The cardinality ratios of 1:1, 1:n and m:n | | |
| are interpreted as cardinality constraints imposed on ODMGRelationship. Below we | | |
| express the OneToOne and OneToMany constraints assuming for the latter that the | | |
| originator ODMGClass instance is the one sitting at the Many-end of the relationship. | | |
| ODMGRelationship free of constraints represents the m:n case. | | |
| Relationship | Relationship | Relationship |
| ODMGRelationship{ | ODMGRelationship{ | ODMGRelationship{ |
| from: ODMGClass | from: ODMGClass | from: ODMGClass |
| to: ODMGClass | to: ODMGClass | to: ODMGClass |
| } | constrainedBy: | constrainedBy: |
| | OneToMany | OneToOne |
| | } | } |

Constraint OneToOne: (∀i instanceOf this,∀k1,k2 instanceOf i, [symbol] (k1 = k2) [symbol] [symbol]
(from(k1) = from(k2)) AND [symbol] (to(k1) = to(k2))
Constraint OneToMany: (∀i instanceOf this,∀k1,k2 instanceOf i, [symbol] (k1 = k2) [symbol] [symbol]
(to(k1) = to(k2))
inheritance in ODMG is represented as a MOP Relationship augmented with the
inheritance constraint. InheritsFrom is modelled exactly as in XML examined in the
previous section.

An example follows that illustrates the ODMG-to-MOP mappings in more detail.
ODMG

| | | |
|---|---|---|
| class Salary{ | class Employee{ | class Professor extends |
| attribute float base; | attribute string name; | Employee{ |
| attribute float overtime; | attribute short id; | attribute string rank; |
| attribute float bonus; | attribute Salary salary; | relationship |
| } | void hire( ); | set<Section> teaches |
| class Section { | void fire( ) raises | inverse Section:: |
| attribute string number; | (no_such_employee); | is_taught_by; |
| relationship Professor | } | } |
| is_taught_by inverse | | |
| Professor::teaches; | | |
| } | | |
| MOP | | |
| StateClass Base{ | StateClass Name{ | Relationship teaches{ |
| type: ODMGAttribute | type: ODMGAttribute | type: ODMGRelationship |
| contentType: Float | contentType: String | constrainedBy |
| } | } | OneToMany |
| StateClass Overtime{ | BehaviourClass Hire { | from: Professor |
| type: ODMGAttribute | type: ODMGMethod | to: Section |
| contentType: Float | } | } |
| } | BehaviourClass Fire{ | StateClass Rank{ |
| StateClass Bonus{ | type: ODMGMethod | type: ODMGAttribute |
| type: ODMGAttribute | Relationship | contentType: String |
| contentType: Float | raisesException { | } |
| } | type: ODMGRaises | CollectionClass Professor { |
| Collection Salary { | to: No_Such_Employee | type: ODMGClass |
| type: ODMGClass | } | members: Rank |
| members: Base, | } | Relationship |
| Overtime, Bonus | CollectionClass Employee{ | inheritsPerson{ |
| } | type: ODMGClass | type: inheritsFrom |
| | members: Name, Salary, | to: Person |
| | Hire, Fire | } |
| | } | } |

Relational Model in Object Primitives

The Relational data-model was introduced in “A Relational Model of Data for Large Shared Data Banks”, Codd, Communication of the ACM, Vol 13, No 6, pp 377-387, 1970). The semantics of the Relational data-model are illustrated in FIG. 4.

TABLE 3
Relational to MOP mappings

| Relational constructs | MOP representation |
|---|---|
| Schema | Collection Class |
| Relation | Collection Class |
| Primary Key | Collection |
| Attribute | State Class |
| Foreign Key | Collection |
| Attribute | State Class |
| Primary Key | Collection Class |
| Foreign Key | Collection Class |
| View | Collection Class |
| Attribute | State Class |

Table 3 presents the mappings between the Relational data-model and MOP. More analytically:

| a schema is a Collection Class. | |
|---|---|
| CollectionClass SQLSchema { | |
| members: SQLRelation | |
| } | |
| An instance of SQLSchema aggregates MOPClasses that represent relations. | |
| a relation contains attributes therefore it is modelled as a Collection Class | |
| CollectionClass SQLRelation{ | |
| members: SQLKey, SQLAttribute | |
| } | |
| an attribute in the relational model can only be of literal type, such as integer or | |
| string, hence it is represented as a StateClass. Again, as in the case of the ODMG- | |
| MOP mappings, the relational literal types get mapped to the built-in MOP literals | |
| StateClass SQLAttribute { | |
| } | |
| a key is a set of one or more attributes. Hence, it is mapped to a Collection Class. A | |
| key aims at uniquely identifying each tuple in a relation. In other words, a key | |
| instance identifies one tuple and one tuple is identified by only one key instance. | |
| Therefore, we introduce the Identifies MOP Relationship that engages the | |
| SQLPrimaryKey and SQLRelation Collections into a 1:1 association. The 1:1 property | |
| of Identifies is represented by the OneToOne constraint, which is defined in the | |
| previous section. | |
| CollectionClass SQLPrimaryKey{ | Relationship ldentifies{ |
| members: SQLAttribute | from: SQLPrimaryKey |
| } | to: SQLRelation |
| | constrainedBy: OneToOne |
| | } |

```
a foreign key is a set of attributes that comprises the key of another relation. Hence,
it is represented with the same Collection Class that models the respective key and it
is contained in the SQLRelation that models the relation of which the foreign key is
part.
a view is composed of attributes that stem from different relations. It is modelled as a
Collection Class with SQLAttribute members.
CollectionClass SQLView {
  members: SQLAttribute
}
  An example is given below in order to depict the representation of a Relational
```

```
schema in MOP. The underlined attributes correspond to the key and the italicised ones
to the foreign key.
Relational
Employee (EmpID, Name)
Department(SectionNo, DepartmentNO, EmpID)
MOP
StateClass SectionNo {
  type: SQLAttribute
  contentType: Integer
}
StateClass DepartmentNo{
  type: SQLAttribute
  contentType: Integer
}
CollectionClass DeptKey{
  type: SQLPrimaryKey
  members: SectionNo, DepartmentNo
}
CollectionClass Department{
  type: SQLRelation
  members: DeptKey, EmployeeKey
}
```

Application of MOP to the Problem of Integration of Heterogenous Resources

By way of example, an application of the Object Primitives model to the problem of the integration of heterogenous resources will now be discussed.

FIG. 5 illustrates components in an architecture for implementing an embodiment of an apparatus and method according to one aspect of the invention.

A first, second, third, fourth and fifth computer 500, 502, 504, 506, 508 are connected together by means of a network 510. Suitable general purpose computers are well known; suitable networks including Local Area Networks (LANs) and Wide Area Networks (WANs) are also well known.

Application software executed on each respective computer provides for functionality in respect of network communication and the provision of a middleware environment. One such typical middleware environment is that provided by CORBA (See, for example, “Instant CORBA”, Orfali et al, John Wiley, 1997).

The first computer 500 executes a software application to provide the functionality according to the invention as described herein. This software application program can be loaded onto the first computer by any suitable means. A computer readable medium 501 such as a floppy disk, a CD-ROM or DVD-ROM can be used to store the software application. Alternatively, the software application could be downloaded over a suitable connection, for example a network connection.

The second, third and fourth computers, 502, 504, 506 host resources. For the purposes of this embodiment, the second computer 502 is taken to host a relational database, the third computer 504 an object-oriented database and the fourth computer an extensible Markup Language (XML) database.

FIG. 6A illustrates a schematic representation of the structure of the relational database 600 hosted by the second computer 502. The subject matter data of the database is stored in one or more data tables 602. The database 600 is also provided with a metadata store 604, which provides descriptions of the data tables. Further an API module 606 allows remote interrogation.

FIG. 6B illustrates a schematic representation of the structure of the object-oriented database 608 hosted by the third computer 504. The subject matter data of the database is stored in one or more objects 610. The database 608 is also provided with a metadata store 612, which provides descriptions of, for example, the object classes and interfaces. Again, an API module 614 allows remote interrogation.

FIG. 6C illustrates a schematic representation of the structure of the XML database 616 hosted by the third computer 606. The subject matter data of the database 616 is stored in one or more XML documents 618. The database 616 is also provided with a metadata store 620, which provides descriptions of, for example, the XML Document Type Definitions (DTDs). Again, an API module 622 allows remote interrogation.

The fourth computer 508 hosts a resource directory service.

FIG. 6D illustrates a schematic representation of the structure of this resource directory service 624. These resources may take the form of, for example, C functions or objects, and typically will reside on a variety of computers within the network. These resources may however be remotely invoked over the network.

The resource directory has a metadata store 626 in which an interface library is provided. The remote invocation of each such resource is performed through an associated interface. Interface definitions will be provided in respect of C function resources. Class and interface catalogues will be provided in respect of object resources. Again, an API module 628 allows remote interrogation.

In each of the above cases, the middleware environment will provide that, by means of a function call in a client computer API, interfacing with the information source or directory API, a description of the resources publically available throughout the network can be returned to the client computer. Typically these include a schema for each information source, associated information source functionality and functionality distributed throughout the network but published to an interface directory.

When such descriptions are returned to the application, they will identify network resources available in a variety of information or data models. For example, in this case, resources will be identified with relational, object-oriented and XML models. Method functionality will also be identified, through the published interfaces.

Having regard to FIGS. 5 and 7, in a first step 700, interfacing through an API 512, an extractor module 514 performs such an interrogation and thereby receives a description of the available resources.

One or more wrapper modules 516 are provided which effect the transformation between the resource representation in which each respective resource has been identified and MOP. The Model of Object Primitives (MOP) and mappings between MOP and, by way of example, XML, ODMG and the relational data models are as discussed above. A wrapper module 516 mapping into MOP is therefore provided for each of the relational, object-oriented and XML information models. It is to be noted that, for reasons of computational efficiency, pre-stored high-level mappings are preferably pre-created from the publically available specifications of each such model, for example the public specifications of ODMG, XML etc.

In this way, in a second step 702, the one or more wrapper modules 516 perform the transformation of the description of each of the resources identified from their native representations into the MOP representation.

In a third step 704, each such transformed representation is then stored in a repository store 518. These one or more wrapper modules 516 can also perform the reverse transformation, which is to say that when, for example, a function is called in its MOP representation, the wrapper module can transform this function call back into its native representation, as will be discussed further below.

A further program module 520 provides for a resource specification tool.

Once all these resources have been transformed into the MOP representation and stored in the repository 518, the resource specification tool 520 can then cause the contents of the repository to be displayed, as appropriate, to a user of the application. It is to be noted that, of course, whilst the available resources are described in the repository 518, the resources themselves still reside on their native hosts.

The nature of the common MOP representation thus provides for considerable advantage in being suitable for allowing heterogenous resources to be transformed in the common MOP representation, whereupon they can be displayed as an integrated source of resources.

One application capitalising on this advantage in providing for resource creation, is now briefly described.

One suitable method of displaying the contents of the repository 518 is to utilise a Graphical User Interface (GUI) on a display 522. There will be scope for choice on the part of the tool designer as to how the available resources are depicted. A user may interact, as is typical through a keyboard 524 or mouse 526 or any equivalent device.

In a fifth step 708, in response to the display of the contents of the repository, which is to say the sum total of resources available in a MOP representation, the resource specification tool 720 then permits the user to specify a new resource. This specification is performed through determination of the manner in which component resources are to be associated and in which they will consequently interact. Preferably, the association is carried on the basis of a rule specified linkage of components. The new resource is therefore determined on the basis of a so-called declarative specification rather than dependent on particular issues of implementation.

By way of example, when utilising a GUI interface, the specification could be declared in terms of a resource based graph having resources sitting on graph nodes and having their associations specified through edge links.

As soon as the specification of the new resource is complete, the resource specification tool 520 passes the specification to a resource generation module 528. Again as discussed in more detail below, utilising a so-called interpretive mechanism, the resource generation module 528 assembles the new resource. The resource generation module 528 makes reference to the native resource specifications in the repository 518 (to allow location of necessary component network resources, for example, data or objects within data stores and other pre-existing services), and then creates the new resource component (reflecting the now necessary linkages between the component network resources) such as to implement the functionality of the new resource specified with the tool.

In particular, the resource will consist of two parts. A first part is the resource specification where the structure of the resource is defined. A second part is a mechanism for interpreting functionality. This is capable of understanding the structure of the resource as it is defined/pictured in the specification. At runtime, and in case the resource is called upon for use by an application, this mechanism is assigned to implement and execute the specification. By implementation is indicated that the appropriate component resources included in the specification are invoked. By execution is indicated that the mechanism renders the new resource functionally active to perform in the application that uses it as its specification dictates.

The new resource could be assembled directly from the resource specification. Alternatively, in a reverse mapping utilising the wrapper modules 516, the MOP representation of the new resource could be transformed into the correspondingly associated respective representations of the component resources prior to assembling the new resource.

Preferably, the specification is validated. In particular, when rule-based associations have been made, the logical rules defined by the specification will admit of a consistency validation in terms of inputs and outputs.

These newly created objects can then be stored as appropriate. Preferably these new resources have their interfaces published into the directory service such that they themselves become new system resources.

In this way, an advantage provided in accordance with the invention has been utilised in providing for the creation of new resources out of heterogenous component resources.

1. A method of representing a resource, the resource having a plurality of states and associated behaviour defining transition between respective states; said method comprising representing the resource with a chosen combination of semantic elements, wherein the permissible set of semantic elements from which to choose comprises:
a state class representing an element of state;
a behaviour class representing an element of behaviour;
a collection class representing an aggregation of one or more classes;
a relationship class representing an association between two or more classes; and
a constraint representing a logical expression associated with one or more classes.

2. A method of transformation of resource representations, a resource having a plurality of states and associated behaviour defining transition between respective states; the method comprising:
receiving a first representation of the resource;
transforming said first representation of the resource into a second representation of the resource, the second representation of the resource comprising a chosen combination of semantic elements, wherein the permissible set of semantic elements from which to choose comprises:
a state class representing an element of state;
a behaviour class representing an element of behaviour;
a collection class representing an aggregation of one or more classes;
a relationship class representing an association between two or more classes; and
a constraint representing a logical expression associated with one or more classes.

3. A method of integration of heterogenous resources, a plurality of resources each having a plurality of states and associated behaviour defining transition between respective states and each respective resource being associated with a resource representation; the method comprising:
receiving each respective resource representation; and
transforming each respective resource representation into a common resource representation, the common resource representation comprising a chosen combination of semantic elements, wherein the permissible set of semantic elements from which to choose comprises:
a state class representing an element of state;
a behaviour class representing an element of behaviour;
a collection class representing an aggregation of one or more classes;
a relationship class representing an association between two or more classes; and
a constraint representing a logical expression associated with one or more classes.

4. A method of representing a resource, the resource having a plurality of states; said method comprising representing the resource with a chosen combination of component representation types, wherein the permissible set of component representation types from which to choose comprises:
a representation of an element of state;
a representation of an aggregation of one or more representations;
a representation of an association between two or more representations; and
a representation of a logical expression associated with one or more other representations.

5. A method as claimed in claim 4 wherein the resource is further associated with behaviour defining transition between respective states, wherein the permissible set of component representation types further comprises a representation of an element of behaviour.

5. A method according to any one of claims 1 to 4 further comprising permitting the association of a rule with the or each behaviour class.

6. A computer program storage medium, the medium embodying computer readable code for reading into a computer and executable by the computer to perform the method according to any one of claims 1 to 5.

7. A resource representation apparatus, the resource having a plurality of states and associated behaviour defining transition between respective states; said apparatus comprising means arranged to represent the resource with a chosen combination of semantic elements, wherein the permissible set of semantic elements from which to choose comprises:
a state class representing an element of state;
a behaviour class representing an element of behaviour;
a collection class representing an aggregation of one or more classes;
a relationship class representing an association between two or more classes; and
a constraint representing a logical expression associated with one or more classes.

8. A resource representation transformation apparatus, a resource having a plurality of states and associated behaviour defining transition between respective states; the apparatus comprising:
means arranged to receive a first representation of the resource;
means arranged to transform the first representation of the resource into a second representation of the resource, the second representation of the resource comprising a chosen combination of semantic elements, wherein the permissible set of semantic elements from which to choose comprises:
a state class representing an element of state;
a behaviour class representing an element of behaviour;
a collection class representing an aggregation of one or more classes;
a relationship class representing an association between two or more classes; and
a constraint representing a logical expression associated with one or more classes.
